(19) United States
(12) Patent Application Publication
(10) Pub. No.: US 2009/0023441 A1
(43) Pub. Date: Jan. 22, 2009

(54) APPARATUS AND METHOD FOR DETERMINING A DOWNLINK TRANSMIT POWER CHARACTERISTIC IN A CELLULAR COMMUNICATION SYSTEM

(75) Inventor: David P. O'Connell, Wiltshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/278,406

(22) PCT Filed: Feb. 19, 2007
(86) PCT No.: PCT/US07/62378

§ 371 Date: Aug. 6, 2008

(30) Foreign Application Priority Data
Mar. 10, 2006 (GB) 0604924.1

(51) Int. Cl. H04W 24/00

(52) U.S. Cl. 455/424

(57) ABSTRACT

A cellular communication system comprising a network optimizer (117) which may perform performance optimization or evaluation based on measurements by remote stations (101, 103, 115). The network optimizer (117) comprises a remote station measurement controller (203) which instructs a first remote station (101) to report signal strength measurements for a pilot channel of a serving cell. A resulting signal strength measurement indication for the pilot channel is received from the first remote station (101) by a signal strength processor (207) and a transmit characteristic processor (209) determines a downlink transmit power characteristic for a traffic channel for the remote station in response to the signal strength measurement for the pilot channel. The invention may provide compensation for a dynamic downlink power control for the traffic channel without requiring information of the transmit power used by the base station (103).

### FIELD OF THE INVENTION

The invention relates to an apparatus and method for determining a downlink transmit power characteristic in a cellular communication system and in particular, but not exclusively, to determination of a downlink transmit power characteristic in a Global System for Mobile communication (GSM) cellular communication system

### BACKGROUND OF THE INVENTION

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems have recently been rolled out in many areas to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876. The core network of UMTS is built on the use of SGSNs and GGSNs thereby providing commonality with GPRS.

In order to optimise the capacity of a cellular communication system, it is important to minimise the impact of interference caused by or to other mobile stations. Thus, it is important to minimise the interference caused by the communication to or from a mobile station, and consequently it is important to use the lowest possible transmit power.

An important advantage of cellular communication systems is that, due to the radio signal attenuation with distance, the interference caused by communication within one cell is negligible in a cell sufficiently far removed, and therefore the resource can be reused in this cell. In GSM systems, carrier frequencies are therefore reused in other cells in accordance with a frequency plan. Frequency planning is one of the most important optimization operations for a cellular communication system in order to maximise the communication capacity of the system. The frequency planning typically considers a vast number of parameters including propagation characteristics, traffic profiles and communication equipment capabilities.

Specifically, known frequency planning methods rely heavily on interference estimations between different cells. Automatic frequency planning methods have been developed wherein potential cross-interference and resulting carrier to interference ratios are determined for different possible frequency allocations. Typically, an interference level is determined as the interference caused to a communication between a mobile station and a base station in one cell by a potential communication between a mobile station and base station in a different cell. Conventionally, the interference is determined from propagation predictions based on calculated and measured propagation characteristics.

Due to the large number of possible frequency plans and the complex interference interrelations between different cells, frequency planning is typically achieved by use of Automatic Frequency Planning (AFP) tools which can take in a list of interference relationships between cells and interferers to produce a frequency plan that minimises interference. The interference relationships quantify the interference in a cell from each potential interferer. The AFP will then use this information to produce a frequency plan that minimises the effect of the interference. Typically, a complex search and iterative optimization technique is used to determine the best frequency plan.

Other network optimization procedures may seek to improve the performance of the cellular communication system for the current frequency plan. For example network optimization tools may be used to adjust the cell size by adjusting the maximum cell transmit powers of different cells. Such optimization procedures may also be based on interference relationships.

The interference relationships between different cells are frequently determined based on the actual conditions experienced by mobile stations in a live system. Thus, network optimization tools often use mobile station measurement reports to determine the received signal levels from different cells. The signal levels may be used to determine the experienced propagation path loss from different base stations which can be used to determine the interference relationships.

Specifically, in a cellular communication system, such as GSM, the mobile station measures the RF (Radio Frequency) environment of the mobile station and reports this to the serving base station. The serving base station then appends data relating to base station measurements of the mobile station as well as data indicating the actual transmit power levels used for transmitting to the mobile station. This forms a measurement report. The measurement reports are then fed to a network optimization tools which uses this information to determine the radio environment of the mobile station and specifically it may use the received information to calculate values such as signal path loss, C/I (Carrier to Interference Ratio) and interference thresholds. The values received from a large number of mobile stations over a long time interval can then be used for network evaluation and optimization.

However, a problem with the current approach is that it requires information to be provided by both the base station and the mobile station. This process is standardized in the GSM recommendations and, although it provides a useful system in many cases, it is inflexible and tends to provide suboptimal performance. For example, the current approach cannot easily be updated to provide new measurements or to use a different approach in measuring the parameters. OMA-DM (Open Mobile Alliance-Device Management) is a new standard that allows a mobile station to report its RF environment. However, although this standard provides the opportunity of improved mobile station measurements, it is a mobile station standard which does not provide for any enhanced functionality to be introduced to conventional base stations and network infrastructure. Thus, although the application of OMA-DM may provide improved or facilitated measurements, it cannot provide the corresponding information currently provided by the base station.

In many situations it is desirable to use an OMA-DM or similar method of obtaining measurement data rather than relying on conventional measurement reports. For example, in multi-vendor systems obtaining all suitable measurement reports may be a complex operation. However, as OMA-DM does not provide the information available only at the base stations, this is not always practical or feasible. Specifically, it is often desirable to use such approaches to determine the downlink radio conditions experienced by a mobile station. However, many parameters (such as interference levels or carrier to interference ratios) depends on downlink transmit power characteristics for the downlink transmissions from the base station to the mobile stations. However, this information is generally available only at the base station thereby preventing the determination of these parameters.

Hence, an improved system for determining a downlink transmit power characteristic would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for determining a downlink transmit power characteristic in a cellular communication system, the apparatus comprising: means for instructing a first remote station to report signal strength measurements for a pilot channel of a serving cell; means for receiving a first signal strength measurement for the pilot channel from the first remote station; and means for determining a downlink transmit power characteristic for a traffic channel for the remote station in response to the first signal strength measurement.

The invention may allow an improved and/or facilitated determination of downlink transmit power characteristics in a cellular communication system. Specifically, the invention may allow determination of the downlink transmit power characteristic without requiring information of the transmit power used by the serving cell for the traffic channel. Indeed, the invention may allow the determination of the downlink transmit power characteristic based on measurements only performed at the remote station. The invention may obviate or reduce the need for information to be provided by a base station of the cellular communication and may in particular obviate the need for the serving base station to append information to measurement reports from the remote station. The invention may allow the apparatus to directly control the remote station to provide the required information and may thus allow measurements, performance evaluation or optimization processes to be performed by the apparatus based on information directly obtained from the remote station.

The invention may allow a system wherein remote stations are adapted to perform improved measurements without requiring that modifications are introduced to base stations of the system.

The invention may allow compatibility with existing systems such as GSM and may specifically allow a GSM remote station to provide information to an evaluation or optimization server without requiring additional information from the base stations or base station controllers.

The signal strength measurement may be any measurement that provides a direct or indirect indication of the received signal level and may be reported as a direct received signal level or as any other direct or indirect information providing an indication of the received signal level. In the cellular communication system, a dynamic power control may be operated for the traffic channel whereas the pilot channel may use a substantially constant transmit power. The invention may allow for the dynamic variations caused by the power control of the traffic channel to be compensated.

According to an optional feature of the invention, the determining means is arranged to determine a receive signal level for the traffic channel corresponding to a transmit power of the traffic channel equal to a transmit power of the pilot signal.

The invention may allow an efficient determination of a parameter which accurately reflects the impact of base station transmit power characteristics on the radio characteristics for a remote station without requiring information from the base station. The feature may allow improved determination of radio characteristics for remote stations of the cellular communication system thereby allowing improved performance evaluation and/or optimization.

According to an optional feature of the invention, the apparatus further comprises means for receiving a second signal strength measurement for the traffic channel from the first remote station and wherein the determining means is arranged to further determine the downlink transmit power characteristic in response to the second signal strength measurement.

The invention may allow an efficient determination of a parameter which accurately reflects the impact of base station transmit power characteristics on the radio characteristics for a remote station without requiring information from the base station. The feature may allow improved determination of radio characteristics for remote stations of the cellular communication system thereby allowing improved performance evaluation and/or optimization. In particular, the feature may allow determination of a characteristic of a traffic channel based on relative measures between signal levels of the traffic channel and a pilot channel.

According to an optional feature of the invention, the downlink transmit power characteristic is a power control transmit power offset for the traffic channel.

The invention may allow an efficient determination of a parameter which accurately reflects the impact of base station transmit power control characteristics on the radio characteristics for a remote station without requiring information from the base station. The feature may allow improved determination of radio characteristics for remote stations of the cellular communication system thereby allowing improved performance evaluation and/or optimization.

According to an optional feature of the invention, the power control transmit power offset is determined in response to a difference between the first signal strength measurement and the second signal strength measurement.

This may allow a particularly low complexity and/or accurate determination of a suitable parameter.

According to an optional feature of the invention, the determining means is further arranged to determine the downlink transmit power characteristic in response to a down link pilot signal transmit power for the pilot signal.

The invention may allow an efficient determination of a parameter which accurately reflects the impact of base station transmit power characteristics on the radio characteristics for a remote station without requiring information from the base station. The feature may allow improved determination of radio characteristics for remote stations of the cellular communication system thereby allowing improved performance evaluation and/or optimization. The pilot signal transmit power may be substantially constant for the serving cell.

According to an optional feature of the invention, the apparatus further comprises means for receiving an indication of the pilot signal transmit power from an Operations and Maintenance Centre of the cellular communication system.

This may allow a low complexity implementation and may in particular provide improved backwards compatibility with many systems such as GSM.

According to an optional feature of the invention, the downlink transmit power characteristic comprises a downlink transmit power for the traffic channel.

The invention may allow an efficient determination of a parameter which accurately reflects the impact of base station transmit power characteristics on the radio characteristics for a remote station without requiring information from the base station. The feature may allow improved determination of radio characteristics for remote stations of the cellular communication system thereby allowing improved performance evaluation and/or optimization. The downlink transmit power may specifically be the current transmit power set by a dynamic power control loop of the traffic channel.

According to an optional feature of the invention, the determining means is arranged to determine the downlink transmit power characteristic by offsetting the pilot signal transmit power in response to a difference between the first signal strength measurement and the second signal strength measurement.

This may allow a particularly low complexity and/or accurate determination of a suitable parameter.

According to an optional feature of the invention, the apparatus further comprises means for modifying at least one of the first signal strength measurement and the second signal strength measurement in response to a frequency band characteristic for at least one of the traffic channel and the pilot channel.

This may allow improved performance. In particular, it may allow improved accuracy and/or reduced complexity in determining characteristics associated with a traffic channel based on a pilot channel in a different frequency band.

According to an optional feature of the invention, the means for modifying is arranged to offset at least one of the first signal strength measurement and the second signal strength measurement if the traffic channel and the pilot channel are in different frequency bands.

This may allow a particularly low complexity determination of a suitable parameter.

According to an optional feature of the invention, the means for instructing is arranged to instruct the remote station to include the serving cell as a neighbour cell.

This may allow improved performance and/or facilitated operation and/or implementation. In particular, it may allow existing functionality for measuring neighbour cells to be used for determining the downlink transmit power characteristic.

According to an optional feature of the invention, the only dynamic information used to determine the downlink transmit power characteristic is generated at the remote station.

The invention may allow a downlink transmit power characteristic to be determined from measurements performed at the remote station and without requiring any other dynamic information associated with the remote station. This may facilitate implementation of new and/or improved measurement and performance evaluation processes thereby allowing improved optimization and thus an improved performance of the cellular communication system as a whole.

According to an optional feature of the invention, the apparatus is arranged to receive the first signal strength measurement from the remote station in accordance with an Open Mobile Alliance-Device Management (OMA-DM) standard.

The invention may allow improved measurement and remote station radio environment evaluation to be performed and may in particular allow new measurements to be adapted by the remote stations. The feature may allow improved performance and/or facilitated implementation and/or operation. In particular, the invention may allow improved performance for an OMA-DM capable remote station without requiring any specific OMA-DM functionality to be implemented by the base station.

According to an optional feature of the invention, the cellular communication system is a Global System for Mobile communication (GSM).

The invention may allow improved performance for a GSM cellular communication system.

According to another aspect of the invention, there is provided a cellular communication system comprising: an apparatus comprising: means for instructing a first remote station to report signal strength measurements for a pilot channel of a serving cell, means for receiving a first signal strength measurement indication for the pilot channel from the first remote station, means for determining a downlink transmit power characteristic for a traffic channel for the remote station in response to the first signal strength measurement; and the first remote station comprising: means for receiving the instruction to measure signal strength measurements for the pilot channel, means for making signal strength measurements on the pilot channel, means for generating the first signal strength measurement indication in response to the signal strength measurements, and means for transmitting the first signal strength measurement indication to the apparatus.

According to another aspect of the invention, there is provided a method of determining a downlink transmit power characteristic in a cellular communication system, the method comprising: instructing a first remote station to report signal strength measurements for a pilot channel of a serving cell; receiving a first signal strength measurement for the pilot channel from the first remote station; and determining a downlink transmit power characteristic for a traffic channel for the remote station in response to the first signal strength measurement.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system in accordance with some embodiment of the invention;

FIG. 2 is an illustration of an optimization server in accordance with some embodiments of the invention;

FIG. 3 is an illustration of a remote station for a cellular communication system in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other cellular communication systems including for example UMTS cellular communication systems.

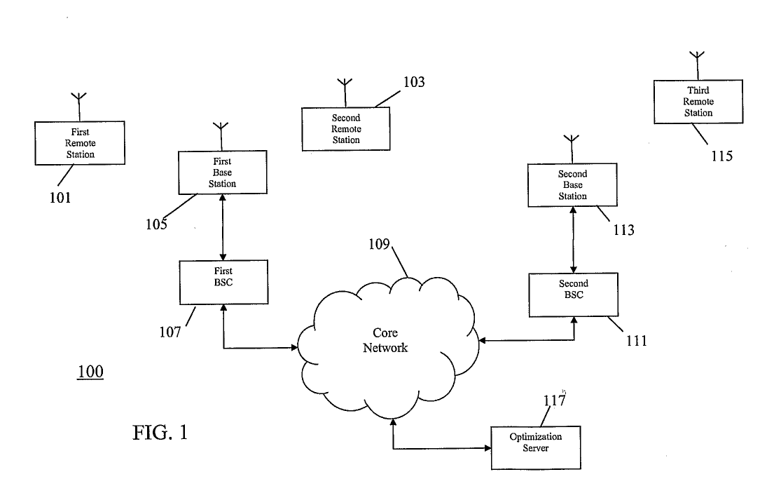

FIG. 1 illustrates an example of a cellular communication system 100 in which embodiments of the invention may be employed.

In a cellular communication system, a geographical region is divided into a number of cells each of which is served by a base station. The base stations are interconnected by a fixed network which can communicate data between the base stations. A remote station (e.g. a User Equipment (UE), a subscriber unit or a mobile station) is served via a radio communication link by the base station of the cell within which the remote station is situated.

As a remote station moves, it may move from the coverage of one base station to the coverage of another, i.e. from one cell to another. As the remote station moves towards a base station, it enters a region of overlapping coverage of two base stations and within this overlap region it changes to be supported by the new base station. As the remote station moves further into the new cell, it continues to be supported by the new base station. This is known as a handover or handoff of a remote station between cells.

A typical cellular communication system extends coverage over typically an entire country and comprises hundreds or even thousands of cells supporting thousands or even millions of remote stations. Communication from a remote station to a base station is known as uplink, and communication from a base station to a remote station is known as downlink.

In the example of FIG. 1, a first remote station 101 and a second remote station 103 are in a first cell supported by a first base station 105.

The first base station 105 is coupled to a first Base Station Controller (BSC) 107. A BSC performs many of the control functions related to the air interface including radio resource management and routing of data to and from appropriate base stations.

The first BSC 107 is coupled to a core network 109. A core network interconnects BSCs and is operable to route data between any two BSCs, thereby enabling a remote station in a cell to communicate with a remote station in any other cell. In addition, a core network comprises gateway functions for interconnecting to external networks such as the Public Switched Telephone Network (PSTN), thereby allowing remote stations to communicate with landline telephones and other communication terminals connected by a landline. Furthermore, the core network comprises much of the functionality required for managing a conventional cellular communication network including functionality for routing data, admission control, resource allocation, subscriber billing, remote station authentication etc. The core network may specifically comprise one or more Mobile Switching Centres (MSCs).

The core network 109 is further coupled to a second BSC 111 which is coupled to a second base station 113. The second base station 113 supports a third remote station 115.

In the example of FIG. 1, the core network 109 is furthermore coupled to an optimization server 117. The optimization server 117 comprises functionality for performing a network optimization for the cellular communication system. Specifically, the optimization server 117 comprises functionality for performing an automatic frequency planning for the cellular communication system. This frequency planning is performed based on performance parameters measured in the cellular communication system during operation.

Accordingly, the optimization server 117 comprises functionality for statistically processing radio environment measurements. As a specific example, the optimization server 117 comprises functionality for developing an interference relationship matrix reflecting the interference relationship experienced between different cell pairs. The automatic frequency planning may be performed based on the interference relationships for different cells as will be appreciated by the person skilled in the art.

The optimization server 117 gathers measurement data from the remote stations 101, 103, 115. However, in contrast to conventional systems, the optimization server 117 does not receive standard GSM measurement reports generated by the base station (and including measurements reported from the remote stations 101, 103, 115). Rather, the optimization server 117 comprises OMA-DM functionality that is used to obtain measurement data directly from the remote stations 101, 103, 115.

OMA-DM is a recently introduced standard which provides for a server downloading and executing specific applications in the remote stations of a cellular communication system. OMA-DM specifically allows software to be downloaded to the remote stations which implement a secure environment in which this software can be executed. Thus, a large variety of applications may be downloaded and executed at the remote station under the control of the server.

In the system of FIG. 1, the optimization server 117 comprises functionality for downloading a measurement application to the remote stations 101, 103, 115. The measurement application may be downloaded as a specific programme code that can be executed at the remote station or may e.g. be downloaded as measurement commands.

OMA-DM provides a potentially cheaper and simpler mechanism for the collection of measurements for use in network optimization tools such as frequency planning tools and services in a multi-vendor environment. However a limitation of a purely OMA-DM based approach is that it only provides the remote stations 101, 103, 115 view of the RF environment. Specifically, the OMA-DM protocol is established between the optimization server 117 and the remote stations 101, 103, 115 whereas the base stations 105, 113 and the BSCs 107, 111 merely provide a suitable communication means for the OMA-DM messages.

As a consequence, information which for a conventional GSM measurement report is introduced by the base stations 105, 113 are not available in the OMA-DM approach. Specifically, the remote stations 101, 103, 115 have no information of the transmit power that is used for the power controlled traffic channels and therefore cannot provide this information to the optimization server 117. This information is required to determine a number of different parameters that are typically used for automatic frequency planning.

In the system of FIG. 1, the optimization server 117 comprises functionality for determining a downlink transmit power characteristic for a power control traffic channel. The optimization server 117 comprises functionality for instructing the remote stations 101, 103, 115 to not only measure the signal strength for the traffic channels but also to measure the received signal strength for a pilot channel and to report this to the optimization server 117. Thus, in a GSM cellular communication system, the optimization server 117 instructs the remote stations 101, 103, 115 to report the received signal strength level of the BCCH of the serving cell. The optimization server 117 furthermore comprises functionality for determining the downlink transmit power characteristic for a traffic channel based on the signal strength measurement for this pilot channel.

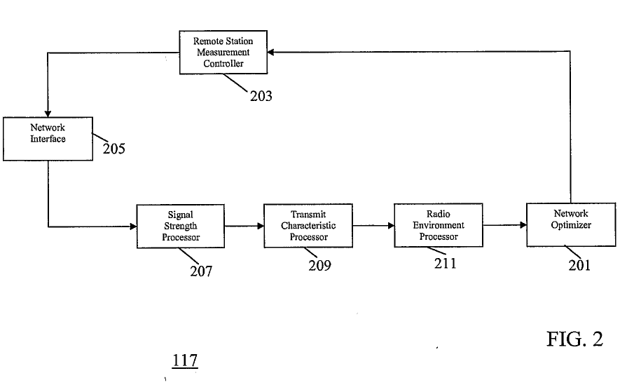

FIG. 2 illustrates the optimization server 117 in more detail.

The optimization server 117 comprises a network optimizer 201 which is capable of performing a network optimization algorithm. In the specific example the network optimizer 201 can perform an automatic frequency planning based on statistical data reflecting the radio environment experienced by remote stations in the cellular communication system. Specifically, the network optimizer 201 can determine an interference relationship matrix comprising the interference relationships between cell pairs of the cellular communication system. The interference relationship matrix is determined on the basis of receive signal level measurements performed by the remote stations 101, 103, 115.

The network optimizer 201 is coupled to a remote station measurement controller 203 which is capable of sending instructions to the remote stations 101, 103, 115 instructing them to perform specified measurements and report the measurement data back to the network optimizer 117.

In the example, the network optimizer 201 indicates to the remote station measurement controller 203 that downlink signal level measurements are required. In response the remote station measurement controller 203 generates instructions for the remote stations 101, 103, 115 to perform these signal level measurements. The remote station measurement controller 203 comprises OMA-DM functionality and specifically generates commands and/or measurement application programme code which is transmitted to the remote stations 101, 103, 115 using an OMA-DM protocol.

The remote station measurement controller 203 is coupled to a network interface 205 which interfaces the optimization server 117 to the core network 109. The OMA-DM messages are transmitted from the remote station measurement controller 203 to the remote stations 101, 103, 115 via the network interface 205, the core network 109 and the appropriate BSCs 107, 111 and base stations 105, 113.

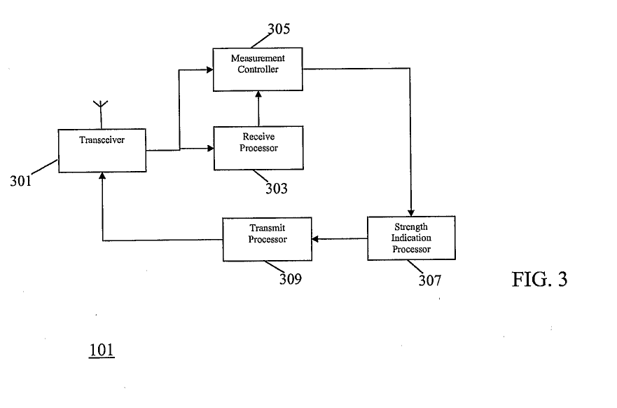

FIG. 3 illustrates the first remote station 101 in more detail. The first remote station 101 comprises a transceiver 301 which contains radio circuitry for communicating with the first base station 103 over the GSM air interface.

The transceiver 301 is coupled to a receive processor 303 which receives the OMA-DM message from the optimization server 117. The receive processor 303 is coupled to a measurement controller 305 which is furthermore coupled to the transceiver 301. When the receive processor 303 receives the OMA-DM message instructing it to perform signal level measurements, it proceeds to control the measurement controller 305 to actually make these measurements in accordance with the specific parameters and requirements indicated by the OMA-DM message.

In contrast to conventional systems wherein pilot signal levels are only measured for neighbour cells and not for the serving cell, the remote station measurement controller 203 generates an OMA-DM message that instructs the remote stations 101, 103, 115 to measure the received signal level of a pilot signal transmitted by the base station of the serving cell. Accordingly, the measurement controller 305 proceeds to measure the received signal strength of a pilot signal from the serving cell, i.e. from the first base station 103. Thus, the measurement controller 305 generates a signal strength measure for the BCCH of the first base station 103.

It will be appreciated that any suitable method or approach for instructing the remote stations 101, 103, 115 to measure the pilot channel signal levels of their serving cell may be used. In the system of FIG. 1, the remote station measurement controller 203 instructs the remote stations 101, 103, 115 to include a serving cell as a neighbour cell. Conventional GSM remote stations continuously monitor the pilot signal levels received from neighbouring base stations in order to determine whether a handover should be performed. Thus, functionality already exists for making pilot channel signal level measurements and by instructing the remote stations 101, 103, 115 to treat the serving cell as a neighbour cell reuse of this functionality can be achieved.

In the example, the measurement controller 305 thus generates received downlink signal level measurements for a pilot channel of the serving cell. In addition, the measurement controller 305 performs measurements of the received downlink signal level in at least one traffic channel. In contrast to the pilot channel, which is transmitted with a substantially constant power, the transmit power used by the first base station 103 for the traffic channel can vary substantially depending on the current propagation conditions between the first base station 103 and the first remote station 101. Specifically, in GSM, dynamic power control is applied to the traffic channels but not to the pilot BCCH channels.

The measurement controller 305 is coupled to a strength indication processor 307 which generates indications of the measured signal strengths. It will be appreciated that any data that may provide an indication of the measured signal levels can be used. In the example, the strength indication processor 307 generates an RxLev indication in accordance with the specifications for GSM.

The strength indication processor 307 is coupled to a transmit processor 309 which is fed the determined RxLev indications. The transmit processor 309 proceeds to generate OMA-DM messages comprising the RxLev indications and to transmit these to the optimization server 117 via the transceiver 301, the first base station 103, the first BSC 107 and the core network 109.

Thus, in contrast to conventional systems, the remote stations 101, 103, 115 can use OMA-DM functionality to provide measurement data. In addition, the remote stations 101, 103, 115 not only provide measured received signal levels for the traffic channels but also for the pilot channel of the serving base station. Furthermore, the measurement reports are generated at the remote stations and communicated directly to the optimization server 117 without requiring any modification by any intervening network element and specifically without requiring any additional information to be provided by the base station.

The optimization server 117 further comprises a signal strength processor 207 which receives the OMA-DM messages from the remote stations 101, 103, 115 and extracts the received signal level indications. The signal strength processor 207 is coupled to a transmit characteristic processor 209 which is fed the received signal strength indications from the remote stations 101, 103, 115. In response, the transmit characteristic processor 209 determines a downlink transmit power characteristic for the traffic channel of the remote station 101 using the signal strength measurement of the pilot channel.

Specifically, the transmit characteristic processor 209 can determine a downlink transmit power characteristic for the traffic channel which compensates for or removes the impact of the dynamic power control of the traffic channel. Thus, the transmit characteristic processor 209 can determine a parameter which provides an indication of the radio environment in which the remote station is operating.

The transmit characteristic processor 209 is coupled to a radio environment processor 211 which can process the received measurement data statistically to provide radio environment data that can be used by the network optimizer 201. Specifically the radio environment processor 211 can determine the cell interference relationship matrix which is used by the frequency planning algorithm of the network optimizer 201.

Thus, the transmit characteristic processor 209 can determine a downlink transmit power characteristic for the traffic channel which compensates for the downlink power control on the traffic channel. For example, the transmit characteristic processor 209 can determine a traffic channel receive level as if power control had not been used for the traffic channel or can determine the radio transmit power for the traffic channel in situations were the instantaneous transmit power is unknown.

As a first example, the transmit characteristic processor 209 can determine a receive signal level for the traffic channel corresponding to a transmit power for the traffic channel being equal to the transmit power of the pilot signal. Hence, the determined receive level corresponds to the receive level that would be experienced in the traffic channel if no power control was applied and the traffic channel transmit power was equal to the BCCH transmit power.

The transmit characteristic processor 209 can specifically calculate this value substantially as:

Comp_RxTCH=RxBCCH

where Comp_RxTCH is the compensated traffic channel receive level and RxBCCH is the receive level for the pilot channel.

As another example the transmit characteristic processor 209 can determine the value of the power control applied to the traffic channel. Thus, the transmit characteristic processor 209 can determine the power control transmit power offset between the maximum transmit power for the base station (corresponding to the transmit power applied on the pilot channel) and the actual instantaneous transmit power used for the traffic channel. In order to determine this value, the transmit characteristic processor 209 considers the measured receive levels for both the pilot channel and the traffic channel.

Specifically, the transmit power offset can be determined as the difference between these values:

TCH_Power_Control_Offset=RxBCCH−RxTCH

As another example, the transmit characteristic processor 209 may obtain information of the transmit power used on the pilot signal. In a GSM system, the pilot channel transmit power corresponds to a maximum transmit power setting for each cell. The parameter is a static parameter that may be set by the network operator via the Operations and Maintenance Centre (OMC) of the system. Hence, the pilot channel transmit power for the individual cell may be obtained from the OMC by the optimization server 117.

The pilot channel transmit power can then be used to determine the downlink transmit power characteristic for the measurement reports received from the remote stations 101, 103, 115. Specifically, the actual instantaneous downlink transmit power used by the base station on the traffic channel can be determined in response to the pilot channel transmit power and the measured received downlink signal levels for the traffic and pilot channel, and specifically in response to the difference between these:

TxTCH=MaxTx−(RxBCCH−RxTCH)

where MaxTx is the transmit power for the pilot channel signal.

In some embodiments, the pilot channel and traffic channel may be in different frequency bands experiencing different propagation conditions. For example, for GSM, the pilot channel may be in the 900 MHz frequency band whereas the traffic channel is in the 1800 MHz frequency band.

In such cases, one or both of the signal strength measurements may be compensated for the different propagation conditions in the different frequency bands. Specifically, a fixed offset may be applied reflecting an estimated propagation loss difference between the frequency bands. As a specific example, attenuation at 1800 MHz is typically higher than at 900 MHz and therefore the traffic channel measurement (or the pilot channel measurement) may be offset by a corresponding value. The offset value may for example be determined based on measurements or analytical propagation calculations for the different frequency bands.

In such cases, the above specific exemplary downlink transmit power characteristics may be modified as follows:

Comp_RxTCH=RxBCCH−PropOffset

TCH_Power_Control_Offset=(RxBCCH−PropOffset)−RxTCH)

TxTCH=MaxTx−((RxBCCH−PropOffset)−RxTCH)

where PropOffset is the compensation offset introduced to account for the different propagation characteristics of the different frequency bands on the same cell.

It will be appreciated that in other embodiments more complex compensation values may be used and that the compensation offset can be a fixed offset or dynamically calculated on a per cell basis.

Hence, the described system allows an optimization server to compensate measured values for downlink transmit power variations without requiring any information of the actual transmit power used in a traffic channel from any network element (except the remote stations). Thus, in situations where it is not possible to know the downlink transmit power used by the base station in a traffic channel, the current approach still allows this to be calculated and compensated for. This may allow an optimization system to be based only on remote station measurements and may specifically allow performance assessment or optimization to be based on OMA-DM functionality.

Specifically, the described approach allows a difference in nominal signal strength (and propagation loss) between serving and neighbor cells to be determined without requiring any dynamic information to be appended by base stations to measurement reports from remote stations. Such, values are very important for network optimization tools, such as automatic frequency planners, and the described approach may thus provide an improved and/or facilitated optimization resulting in improved performance of the cellular communication system as a whole.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for determining a downlink transmit power characteristic in a cellular communication system, the apparatus comprising:
means for instructing a first remote station to report signal strength measurements for a pilot channel of a serving cell;
means for receiving a first signal strength measurement for the pilot channel from the first remote station; and
means for determining a downlink transmit power characteristic for a traffic channel for the remote station in response to the first signal strength measurement.

2. The apparatus of claim 1 wherein the determining means is arranged to determine a receive signal level for the traffic channel corresponding to a transmit power of the traffic channel equal to a transmit power of the pilot signal.

3. The apparatus of claim 1 wherein the apparatus further comprises means for receiving a second signal strength measurement for the traffic channel from the first remote station and wherein the determining means is arranged to further determine the downlink transmit power characteristic in response to the second signal strength measurement.

4. The apparatus of claim 3 wherein the downlink transmit power characteristic is a power control transmit power offset for the traffic channel determined in response to a difference between the first signal strength measurement and the second signal strength measurement.

5. The apparatus of claim 3 wherein the determining means is further arranged to determine the downlink transmit power characteristic in response to a down link pilot signal transmit power for the pilot signal.

6. The apparatus of claim 3 wherein the downlink transmit power characteristic comprises a downlink transmit power for the traffic channel, and wherein the determining means is arranged to determine the downlink transmit power characteristic by offsetting the pilot signal transmit power in response to a difference between the first signal strength measurement and the second signal strength measurement.

7. The apparatus of claim 1 further comprising means for modifying at least one of the first signal strength measurement and the second signal strength measurement in response to a frequency band characteristic for at least one of the traffic channel and the pilot channel.

8. The apparatus of claim 7 wherein the means for modifying is arranged to offset at least one of the first signal strength measurement and the second signal strength measurement if the traffic channel and the pilot channel are in different frequency bands.

9. The apparatus of claim 1 wherein the means for instructing is arranged to instruct the remote station to include the serving cell as a neighbour cell.

10. A method of determining a downlink transmit power characteristic in a cellular communication system, the method comprising:
instructing a first remote station to report signal strength measurements for a pilot channel of a serving cell;
receiving a first signal strength measurement for the pilot channel from the first remote station; and
determining a downlink transmit power characteristic for a traffic channel for the remote station in response to the first signal strength measurement.
